(19) United States
(12) Patent Application Publication
(10) Pub. No.: US 2021/0187548 A1
(43) Pub. Date: Jun. 24, 2021

(54) METHOD FOR PRETREATING SUBSTRATES MADE OF PLASTIC

(71) Applicants: BASF SE, Ludwigshafen am Rhein (DE); BASF Coatings GmbH, Müenster (DE)

(72) Inventors: Jens-Henning Noatschk, Muenster (DE); Simon Winzen, Muenster (DE); Sebastian Hartwig, Muenster (DE); Julio Albuerne, Lemfoerde (DE)

(21) Appl. No.: 16/760,994

(22) PCT Filed: Nov. 12, 2018
(86) PCT No.: PCT/EP2018/080949

§ 371 Date: May 1, 2020

(30) Foreign Application Priority Data
Nov. 30, 2017 (EP) 17204606.2

(51) Int. Cl. B05D 7/00; C08J 7/046; C08J 9/36; C09D 175/04; B05D 1/02; B05D 3/00; B05D 7/04; A43B 13/12; A43B 13/04

(52) U.S. Cl. CPC B05D 7/574; C08J 7/046; C08J 9/365; C09D 175/04; B05D 1/02; B05D 3/007; C08J 2375/04; B05D 7/534; B05D 7/572; A43B 13/127; A43B 13/04; C08J 2475/04; B05D 7/04

(57) ABSTRACT

Provided herein is a process for the pretreatment coating and subsequent lacquering of plastics substrates, wherein a pretreatment layer is produced on a plastics substrate via application, onto the plastics substrate, of a solution or dispersion including at least one organic solvent (L) and, dispersed or dissolved therein, at least one plastic (K), and subsequent evaporation to remove the organic solvent. Then a lacquer layer is produced on the pretreated plastics substrate.

The present invention relates to a process for the pretreatment coating and subsequent lacquering of plastics substrates, where, via application of a specific solution or dispersion comprising a dissolved Or dispersed plastic onto a provided plastics substrate, a pretreatment layer is produced on the plastics substrate, and at least one lacquer layer is subsequently produced on the pretreatment layer via application of at least one lacquer. The present invention also relates to a plastics substrate which has been produced by the above-mentioned process, equipped with a pretreatment layer and with at least one lacquer layer. The composites thus pretreated have not only a high-quality appearance and good haptic properties but also excellent adhesion of the lacquer layer applied on the pretreatment layer. The overall result is therefore a composite material of extremely high quality in respect of adhesion and therefore also of mechanical stability of lacquer layers. The process can therefore be used particularly effectively in those sectors where optical quality and mechanical stability of applied lacquer layers are equally essential. The process is useful by way of example, but not only, in the shoe industry for the lacquering of, in particular, shoe soles such as middle soles made of foam substrates.

### Prior Art

When plastics substrates are subjected to downstream coating, for example are coated with lacquers, adequate adhesion of the lacquer layer is of prime importance. In the absence of this adhesion, the resultant composite material cannot be used as intended.

The properties mentioned are particularly relevant to flexible foam substrates. Foams have become well established as substrate materials for a very wide variety of applications in many industrial sectors, because they feature good processability, low density and versatility in relation to adjustment of property profiles (rigid foams, semirigid foams and flexible foams, thermoplastic foams and elastomeric foams). The shoe industry by way of example often uses compressible, resilient foams for the production of shoe soles, for example middle soles. Shoe soles are obviously exposed to very large mechanical stresses. Walking and running require on the one hand high flexibility and/or resilience of soles, and on the other hand an appropriate level of resistance to exterior mechanical effects. A decisive factor in the case of lacquered foam substrates (provision of color and/or of special effects in order to improve appearance, and/or clearcoat lacquering in order to improve abrasion resistance or soiling resistance) is therefore in particular the adhesion of the lacquer layer during correct use of the appropriate composite material.

Another circumstance requiring attention in connection with plastics substrates is that the process for production of the substrates generally requires the use of auxiliaries, for example waxes and silicone oils, which are essential as release agents by way of example for the demolding of the material from appropriate molds.

The use of a plastics substrate in many industrial sectors therefore generally requires complicated cleaning of the substrate surface, for example by repeated wiping of the surface with a very wide variety of organic solvents, because without this cleaning it would be impossible to achieve acceptable further processing, for example adhesive bonding of the plastics substrates, or further coating, for example lacquering. The reason for this is that, as is known, the auxiliaries described lead to extremely poor adhesion of applied components such as adhesives or lacquers.

The cleaning operations described are firstly very complicated and secondly imply substantial pollution of the environment. An additional factor is that many organic solvents which can achieve an acceptable cleaning effect without an excessive number of repetitions often have to be avoided because they are hazardous to the environment or to health. Reference may be made by way of example to tetrahydrofurans or N-methyl-2-pyrrolidone.

An additional factor is that the auxiliaries described are also present in the body of the material (and not merely at the surface), and can migrate progressively to the surface over the course of time. This progressive accumulation of these components at the surface can self-evidently per se have an adverse effect on the durability of composite materials in which plastics substrates have been processed via, for example, adhesive bonding, or on the lacquering of plastics substrates, because said accumulation in turn results in poor adhesion.

The closest prior art WO 2016/188656 A1 and/or WO 2016/188655 A1 describes the lacquering of a plastics substrate with at least one specific water-based lacquer. This gives a lacquered plastics substrate which has a high-quality appearance and haptic properties and moreover excellent mechanical robustness and flexibility. The main application sector is soles in the shoe industry. It is moreover stated that good adhesion of the lacquer layer is achieved. No reference is made to cleaning of the plastics substrate before application of the lacquer. The person skilled in the art will realize that even if this cleaning is not mentioned it has nevertheless been carried out, because cleaning of a plastics substrate before application of possible coatings is regarded in the prior art as a familiar and indeed sometimes indispensable procedure, because of the abovementioned auxiliaries such as waxes and silicone oils.

WO 2015/165724 A1 describes moldings made of foamed beads made of a polyurethane (A) and of a coating made of polyurethane (B), where the polyurethanes are at least similar. The coating made of polyurethane (B) is constructed via a process where the polyurethane (B) is dissolved in a solvent such as THF, ethylacetate, methylethylketone or acetone, the solution is then applied onto the polyurethane (A), and then the solvent is removed by drying. A particular advantage mentioned is the mechanical robustness and abrasion resistance of the molding. There is no description of any downstream lacquering of the molding. Nothing is moreover said relating to any cleaning of the plastics substrate before application of the solution made of polyurethane (B). The person skilled in the art will realize that even if this cleaning is not mentioned it has nevertheless been carried out, because cleaning of the plastics substrate before application of possible coatings is regarded in the prior art as a familiar and indeed sometimes indispensable procedure, because of the abovementioned auxiliaries such as waxes and silicone oils.

### Object

Even if adhesion of the lacquer layer is described as good in the closest prior art, an improvement is desirable here. This is in particular the case if the intention is to omit the complicated and environmentally problematic cleaning described above, because that is precisely the situation where the problems of adhesion are particularly evident. It was therefore an object of the present invention to provide a process which can give a lacquered plastics substrate that has the good optical and haptic properties described in the closest prior art but has improved adhesion of the lacquer layer on the substrate, even when cleaning of the plastics substrate is omitted.

### Technical Achievement of Object

It has been found that the objects mentioned could be achieved via a process for the pretreatment coating and subsequent lacquering of plastics substrates, where the process comprises the following steps:

(1) Provision of a plastics substrate (S) for pretreatment,

(2) Production of a pretreatment layer on the plastics substrate (S) from (1) via

(2.1) Application, onto the plastics substrate, of a solution or dispersion comprising at least one organic solvent (L) and, dispersed or dissolved therein, at least one plastic (K), and

(2.2) Evaporation to remove the at least one organic solvent from (2.1),

(3) Production of a lacquer layer on the pretreated plastics substrate from (2) via

(3.1) Application of a lacquer onto the pretreated plastics substrate from (2) and

(3.2) Curing of the lacquer from (3.1).

The abovementioned process is hereinafter also termed the process of the invention, and is accordingly provided by the present invention. Preferred embodiments of the process of the invention can be found in the remainder of the description below, and also in the dependent claims.

The present invention further provides a plastics substrate which has been produced by the abovementioned process, equipped with a pretreatment layer and with a lacquer.

The process of the invention and the plastics substrate of the invention have the properties described in the introduction, and in particular combine a high-quality appearance and good haptic properties with excellent adhesion of the lacquer layer on the substrate. It is moreover possible for the purposes of the process to omit the complicated cleaning of the plastics substrate by organic solvents, without any resultant disadvantages in respect of adhesion.

### DETAILED DESCRIPTION

In step (1) of the process, a plastics substrate (S) is provided for pretreatment.

For the purposes of the present invention, preference is given to flexible plastics substrates, in particular flexible foam substrates, because the properties mentioned in the introduction are particularly important in the coating of those substrates.

Brief mention may be made of the fundamental features of foam substrates. Materials regarded as foam substrates are simply any of the substrates known in this connection to the person skilled in the art. Materials that can be used are therefore fundamentally foams produced from thermosets, from thermoplastics, from thermoplastic elastomers or from other elastomers, i.e. those obtained via appropriate foaming processes from plastics from the classes of plastics mentioned. With regard to their chemical basis, non-exclusive examples of polymers that can form foams are polystyrenes, polyvinyl chlorides, polyurethanes, polyesters, polyethers, polyetheramides and polyolefins such as polypropylene and polyethylene, and ethylene-vinyl acetate, and copolymers of the polymers mentioned. It is, of course, also possible that a foam substrate comprises a number of the polymers and copolymers mentioned.

Preferred foam substrates are flexible foam substrates, with particular preference flexible thermoplastic polyurethane foam substrates. The latter are foam substrates comprising thermoplastic polyurethane as polymeric plastics matrix. A fundamental feature of substrates of this type is that they are compressible and resilient.

The foams are then produced by using appropriate foaming processes to foam the thermoplastic polyurethane, i.e. to convert said polyurethane to a foam.

Foaming processes are known, and will therefore be only briefly described. A fundamental principle in all cases is that blowing agents and/or gases produced during crosslinking reactions during the production of appropriate polymeric plastics and dissolved in the plastic or in an appropriate plastics melt are liberated and thus bring about the foaming of the hitherto comparatively dense polymeric plastics. If, by way of example, a low-boiling-point hydrocarbon is used as blowing agent, this evaporates at elevated temperatures and leads to foaming. Gases such as carbon dioxide or nitrogen can also be introduced and/or dissolved as blowing agent into the polymer melt at high pressure. The melts then foam during escape of the blowing agent gas as a result of subsequent pressure decrease.

The foaming can by way of example take place directly during the shaping of appropriate plastics substrates, for example during extrusion or during injection molding. The pressurized plastics melt with admixed blowing agent can by way of example be foamed on discharge from an extruder as a result of the pressure decrease that then occurs.

It is also possible to begin by producing pellets made of thermoplastic comprising blowing agent, and then to foam these pellets in a downstream process in a mold, where the bead pellets increase their volume, fuse with one another and finally form a molding (also termed molded thermoplastic foam) consisting of fused expanded foam beads. The expandable pellets can by way of example be obtained by way of extrusion and subsequent pelletization of the polymer strand leaving the extruder. Pelletization is achieved, for example, by way of appropriate cutting devices, where the conditions of pressure and of temperature used prevent any expansion. The subsequent expansion and fusion of the pellets is generally achieved with the aid of steam at temperatures around 100° C.

It is equally possible to produce molded thermoplastic foams by starting from prefoamed plastics pellets. These are pellets where the sizes of the pellet beads or polymer beads are already significantly larger than those of pellets that have not been prefoamed, their densities being appropriately reduced. Beads with a controlled degree of prefoaming can be produced via appropriate process control, for example as described in WO 2013/153190 A1: extruded polymer strands leaving the extruder can be transferred into a pelletizing chamber with a stream of liquid, where the liquid is under a specific pressure and has a specific temperature. Specific expanded or pre-expanded thermoplastics pellets can be obtained by appropriate adjustment of process parameters, and can be converted into molded thermoplastic foam substrates via subsequent fusion and optionally further expansion with, in particular, steam.

Molded thermoplastic foams and appropriate thermoplastic expandable and/or expanded plastics pellets from which these molded foams can be produced are described by way of example in WO 2007/082838 A1, WO 2013/153190 A1 and also WO 2008/125250 A1. Those documents also describe process parameters and starting materials for the production of thermoplastic polyurethanes, and process parameters for the production of pellets and of molded foams.

Molded thermoplastic foams are in particular amenable to very cost-effective large-scale industrial production and moreover have a particularly advantageous property profile: molded thermoplastic foams can be produced from thermoplastics, in particular polyurethanes, which have excellent flexibility or elasticity and mechanical stability. They are generally compressible and have good resilience. These particular foams accordingly have particularly good suitability as foam substrates for applications in sectors such as the shoe industry. Very particularly preferred substrates are therefore compressible, resilient molded foam substrates which comprise thermoplastic polyurethane as polymeric plastics matrix.

The substrates, preferably the flexible foam substrates, can per se be of any desired shape, i.e. they can for example be simple flat substrates or else have shapes of greater complexity, particular examples being shoe soles such as middle soles.

For the purposes of the present invention, preference is in particular given to molded thermoplastic polyurethane foams as substrates (S).

In step (2) of the process of the invention, a pretreatment layer is produced on the plastics substrate. This is achieved via (2.1) the application, onto the plastics substrate, of a solution or dispersion comprising at least one organic solvent (L) and, dispersed or dissolved therein, at least one plastic (K), and (2.2) evaporation to remove the at least one organic solvent.

The term “solution” means, in accordance with the familiar definition, a homogeneous mixture which is fluid under standard conditions and in which the at least one plastic (as solvate) then appears to be present in solution in the at least one organic solvent, i.e. appears to be in solution at the molecular level therein. The term “dispersion” accordingly means a mixture that is likewise fluid under standard conditions and that likewise has homogeneous character when viewed macroscopically but when viewed microscopically is a heterogeneous mixture of disperse phase (plastic) and continuous phase (solvent).

It is self-evidently possible that the solution or dispersion also comprises components other than the constituents (L) and (K). However, it is preferable that the two constituents (L) and (K) make up at least 90% by weight of the total quantity of the solution or dispersion. It is very particularly preferable that the solution or dispersion consists of the two constituents.

The proportion of the plastic (K), based on the total quantity of the solution or dispersion, is by way of example 5 to 30% by weight, preferably 10 to 20% by weight.

The plastic (K) which is then dissolved or dispersed is preferably a foam, more preferably a thermoplastic polyurethane foam, very particularly preferably a molded thermoplastic polyurethane foam.

It is preferable that the dissolved or dispersed plastic (K) corresponds to the plastics material of the plastics substrate (S) for pretreatment: accordingly, it is ensured that the pretreatment layer and the substrate consist of the same plastics material. An extremely strong bond is thus achieved between the original substrate and the pretreatment layer applied thereon.

It is preferable that no cleaning of the plastics substrate (S) by organic solvents is carried out before the application of the solution or dispersion or before the step (2) of the process of the invention. It is more preferable that no cleaning by organic solvents is carried out in the entire process.

Surprisingly, a very good bond between original substrate and the pretreatment layer applied thereon can nevertheless be achieved in step (2). The pretreatment layer in turn covers the auxiliaries described in the introduction, for example waxes and silicone oils, and also achieves this in the long term in relation to possible migration effects. For this reason it is then possible in the step (3) described at a later stage below to achieve the production of a lacquer layer having excellent adhesion to the substrate.

The selection of the at least one organic solvent (L) is such that it is capable of dissolving or dispersing the selected and desired proportion of the selected plastic (K). The person skilled in the art can make a selection in an individual case via a few carefully designed experiments. Examples of possible materials here are N-methylpyrrolidone, tetrahydrofuran, ethyl acetate, methyl ethyl ketone, acetone, and also dimethylformamide and dichloromethane. A solvent that can likewise be used is methyl 5-(dimethylamino)-2-methyl-5-oxopentanoate, which is a solvent that is free from problems relating to the environment or to health and which in particular has good capability for dissolving or dispersing the preferred polyurethane-based plastics (K).

In a specific embodiment of the present invention, the solution or dispersion is produced by way of a two-stage process. In a first step, the plastic is subjected to solvation or incipient swelling in a first organic solvent, and, in a second step, the mixture from the first step is mixed with a second organic solvent and the solution or dispersion is thus produced.

It has been found that individual selection of the solvents with reference to the respective plastic used achieves very effective dissolution or dispersion, this being significantly better than a procedure using only one solvent or two solvents used simultaneously. Reference may be made by way of example in particular to high-molecular-weight molded thermoplastic polyurethane foams. Whereas these are not amenable, or only very small quantities thereof are amenable, to dissolution or dispersion in methyl ethyl ketone, appropriate solutions or dispersions can be produced without difficulty after incipient swelling in methyl ethyl ketone and subsequent mixing with methyl 5-(dimethylamino)-2-methyl-5-oxopentanoate.

Application (2.1) of the solution or dispersion can be achieved in various ways, for example by spreading, brushing, rolling, casting, dip-coating, rubbing or pneumatic spray application, or by means of a metering applicator. The application method used can be selected appropriately for the conditions of the individual case, and depends by way of example on the viscosity of the solution or dispersion and thus also on the selection of the organic solvent (L) and on the nature and quantity of the dissolved or dispersed plastic (K). However, the existence of this possibility of appropriate selection, and in particular the possibility of spray application, is a decisive advantage. The present invention provides major advantages because the process can omit the complicated cleaning of the substrate surface to remove, for example, waxes or silicone oils, this being achievable only by wiping with organic solvents (see also above), and because instead of this it is possible to select an application method that is comparatively easy to operate.

The evaporation (2.2) to remove the at least one organic solvent can be achieved with use of thermal and/or convective methods, and it is possible here to use conventional and known devices such as heating tunnels, NIR sources and IR sources, blowers and blow tunnels. However, the evaporation can also be achieved by a purely passive method via storage of the coated plastics substrate at, for example, room temperature. Here again, a decisive factor is that the method is appropriate to the respective solvents (L) used.

The layer thickness of the pretreatment coating produced as in step (2) of the process is preferably from 1 to 45 micrometers, more preferably from 10 to 30 micrometers.

The result of step (2) of the process is a plastics substrate which has been equipped with a pretreatment layer and which is then used as described in the step (3) below.

In the step (3) of the process of the invention, a lacquer layer is produced on the pretreated plastics substrate from step (2) via (3.1) application of a lacquer onto the pretreated plastics substrate and (3.2) curing of the lacquer.

Appropriate lacquering processes, and lacquers used therein, are described by way of example in WO 2016/188656 A1, page 6, third paragraph to page 13, third paragraph, and page 17, first paragraph to page 46, final paragraph.

It is preferable to use water-based basecoat lacquers (i.e. pigmented lacquers) and/or water-based clearcoat lacquers, in particular those described in WO 2016/188656 A1 or WO 2016/188655 A1.

Use of the lacquers gives lacquer layers which are particularly capable of meeting requirements such as optical quality (provision of color and/or of special effects via basecoat lacquers), haptic properties, abrasion resistance and resistance to soiling (in particular clearcoat lacquers). In particular, use of these lacquers provides scope for variation and appropriate adjustment that are significantly greater than those permitted by way of example through possible use of additives and/or pigmentation in the pretreatment solution of step (2), as also described in WO 2015/165724 A1. As a result, the excellent adhesion of which repeated mention has already been made is achieved, and the advantages mentioned in the preceding sentence are therefore achieved without any disadvantage due to possible defective adhesion.

Application (3.1) of the at least one lacquer can be achieved by the methods known to the person skilled in the art for the application of liquid coating compositions, for example by dip-coating, doctoring, spraying, rolling or the like. It is preferable to use spray application methods, for example compressed-air spraying (pneumatic application), airless spraying, high speed rotation or electrostatic spray application (ESTA), optionally in conjunction with hot spray application such as hot air spraying. The lacquers are very particularly preferably applied by way of pneumatic spray application or electrostatic spray application.

The manner of application of the lacquers is such that a layer thickness of the individual lacquer layers after curing is by way of example from 3 to 50 micrometers, preferably from 5 to 40 micrometers.

It is, of course, also possible to apply at least two lacquers, for example a basecoat lacquer (pigmented lacquer) and then a clearcoat lacquer.

These lacquers can also be applied on top of one another without curing of the first-applied lacquer before application of the second lacquer (wet-on-wet application), but instead by way of example with only brief air-drying of the first lacquer before application of the second lacquer. The lacquers are then cured simultaneously. In this case, therefore, the lacquer in (3.1) would be a basecoat lacquer, and a clearcoat lacquer would be applied between the steps (3.1) and (3.2).

The expression “curing of an (applied) lacquer” means the conversion of an appropriate layer to the ready-to-use condition, i.e. to a condition in which the substrate equipped with the respective lacquer layer can be transported, stored and correctly used. A cured lacquer layer is therefore in particular no longer soft or tacky, but instead has undergone conditioning to produce a solid coating film, the properties of which, for example hardness or adhesion on the substrate, undergo no further substantial change, even if it is again exposed to curing conditions such as those described at a later stage below.

The curing (3.2) can be achieved in various ways, as required by lacquers used, for example by a method that is purely physical or thermochemical or else uses high-energy radiation. The terminology is known to the person skilled in the art and to some extent is also considered in detail in the prior art, for example in WO 2016/188656 A1.

The result of step (3) of the process of the invention is a plastics substrate likewise of the invention, equipped with a pretreatment layer and with at least one lacquer layer.

It is self-evidently possible that further steps not explicitly mentioned are also carried out for the purposes of the process of the invention. By way of example, as indicated above, it is possible to apply more than one lacquer layer. However, it is sufficient in the invention to produce one lacquer layer. Equally, it is possible to apply more than one pretreatment layer, but it is preferable here to apply precisely one pretreatment layer.

A feature of the plastics substrate is that, although cleaning by organic solvents can be omitted during production thereof, adhesion of the lacquer to the pretreatment layer is excellent, and moreover good optical, haptic and/or mechanical properties and/or good resistance to soiling are, or can be, achieved.

1. A process comprising the following steps for the pretreatment coating and subsequent lacquering of plastics substrates:
(1) provisioning a plastics substrate (S) for pretreatment,
(2) producing a pretreatment layer on the plastics substrate (S) from step (1) via
(2.1) applying, onto the plastics substrate (S), a solution or dispersion comprising at least one organic solvent (L) and, dispersed or dissolved therein, at least one plastic (K), and
(2.2) evaporating to remove the at least one organic solvent from step (2.1),
(3) producing a lacquer layer on the pretreated plastics substrate from step (2) via
(3.1) applying a lacquer onto the pretreated plastics substrate from step (2) and
(3.2) curing of the lacquer from step (3.1).

2. The process as claimed in claim 1, wherein the plastics substrate (S) is a foam substrate.

3. The process as claimed in claim 2, wherein the foam substrate is a flexible foam substrate.

4. The process as claimed in claim 2, wherein the foam substrate is a thermoplastic polyurethane foam substrate.

5. The process as claimed in claim 1, wherein the plastic (K) which is dissolved or dispersed is a foam.

6. The process as claimed in claim 1, wherein the plastic (K) corresponds to the plastics material of the plastics substrate (S).

7. The process as claimed in claim 1, wherein no cleaning of the plastics substrate (S) by organic solvents is carried out before step (2).

8. The process as claimed in claim 1, wherein the layer thickness of the pretreatment coating produced in step (2) is from 1 to 45 micrometers

9. The process as claimed in claim 1, wherein the lacquer of step (3.1) is a water-based lacquer.

10. The process as claimed in claim 9, wherein the lacquer is a pigmented lacquer (basecoat lacquer) or a clearcoat lacquer.

11. The process as claimed in claim 1, wherein the lacquer of step (3.1) is a pigmented lacquer (basecoat lacquer), and wherein a clearcoat lacquer is applied onto the basecoat lacquer layer in a further step and is then cured together with the basecoat lacquer of step (3.2).

12. The process as claimed in claim 1, wherein the application of step (2.1) and the application as in of step (3.1) are carried out by spray application.

13. The process as claimed in claim 1, wherein the production of the solution or dispersion of step (2.1) comprises, in a first step, the solvation or incipient swelling of the plastic (K) in a first organic solvent and, in a second step, the mixing of the mixture from the first step with a second organic solvent and the resultant production of the solution or dispersion.

14. A plastics substrate produced by the process as claimed in claim 1, wherein the plastics substrate is equipped with a pretreatment layer and with at least one lacquer layer.

15. A shoe sole, wherein the shoe sole is a middle sole, which comprises or consists of the plastics substrate as claimed in claim 14.

16. The process as claimed in claim 4, wherein the foam substrate is a molded thermoplastic polyurethane foam substrate.

17. The process as claimed in claim 5, wherein the plastic (K) which is dissolved or dispersed is a thermoplastic polyurethane foam.

18. The process as claimed in claim 17, wherein the plastic (K) which is dissolved or dispersed is a molded thermoplastic polyurethane foam.

19. The process as claimed in claim 7, wherein no cleaning via single or repeated wiping of the plastics substrate (S) with solvents is carried out before step (2).

20. The process as claimed in claim 8, wherein the layer thickness of the pretreatment coating produced in step (2) is from 10 to 30 micrometers.
